(19) United States
(12) Patent Application Publication
(10) Pub. No.: US 2014/0238600 A1
(43) Pub. Date: Aug. 28, 2014

(54) DECAL TRANSFER PRESS

(71) Applicant: John Edward MAHN, Mirmar Beach, FL (US)

(72) Inventor: John Edward MAHN, Mirmar Beach, FL (US)

(21) Appl. No.: 13/776,898

(22) Filed: Feb. 26, 2013

(51) Int. Cl. B44C 1/17

(52) U.S. Cl. CPC B44C 1/1712
USPC 156/309.9; 156/583.2; 156/366; 156/378

(57) ABSTRACT

A transfer press comprising a frame, an upper platen assembly having an induction heatable upper platen, a lower platen assembly attached to the frame. The lower platen assembly is disposed below the upper platen assembly, and an apparatus is attached to the frame and to the upper platen for moving the upper platen between a raised and lowered position relative to the lower platen and for pressing the upper platen against the lower platen. An induction heater is located adjacent the upper platen for heating the upper platen.

### FIELD OF THE INVENTION

This invention relates generally to an apparatus for pressing two articles together under time, heat, and pressure utilizing an induction heater to provide the heat, and more particularly to such an apparatus especially suitable for transferring by time, heat, and pressure an indicia or decal from its backing to a receiving article, such as a piece of cloth forming the front of a T-shirt.

### BACKGROUND

Decals or indicia transferred by a decal transfer press may be of the thermoplastic type in which the image undergoes a solid-to-liquid-to-solid transition in its transfer from the backing (usually parchment-like paper) to the receiving article, or they may be of the sublistatic type in which the transition is solid-to-gas-to-solid. Unless otherwise specified, the term “decals” when used here means decals, or other decorative, imprinting, or embossing that may be transferred to a receiving article or a heat transfer press.

In transferring the images of decals to cloth, the decal is pressed against the cloth for a time at a temperature that raises the decal and cloth to the melting point of the image-defining material to be transferred. Traditionally, this has been done in decal transfer presses utilizing a movable upper platen having a heating element embedded therein and lowering this platen into pressure engagement with a stationary lower platen assembly on which the decal and underlying cloth are supported. The high thermal mass of the upper platen typically requires a long warm-up time. For this reason, decal transfer presses typically left heated all day, particularly in retail establishments. Apart from consuming power wastefully, the hot platens create a burn hazard for unwary personnel and increase the heat to uncomfortable levels in the working regions of the decal transfer presses.

The hot plate in the upper platen of the traditional clam shell design rests at approximately a 30 degree angle to the horizontal lower platen assembly when in an open position. Thus, the hot plate is exposed to the environment during most of the operation time. When this hot plate is radiating heat into an air conditioned environment, such as a store, the operator must not only pay for the energy to generate the heat in the hot plate, but also to extract that heat from the environment through the air conditioner.

In the past, in an effort to overcome the burning of the operator's hands, a sleeve-like heat shield has been designed to put over the upper hot plate. With such a heat shield, the operator manually inserts the sleeve over the upper hot plate while aligning the garment on the lower plate for lettering. It is then necessary to manually remove the sleeve-like heat shield prior to closing the machine. Due to time and inconvenience required in placing the heat shield over the hot plate and subsequently removing it prior to actual operation of the equipment, many operators have opted to use the devices without heat shields.

Many of these prior art machines, due to their complexity and moving parts, have been of questionable reliability. As a result, many store owners have resorted to the use of multiple machines in order to have backup capability in the event that the first machine becomes inoperative.

A second general type of machine commonly used for transferring images onto fabric has a vertical post and a hot plate which is swingingly cantilevered on the post. The operator places the garment on a platen with the hot plate swung to one side. When the garment and transfer are in proper placement on the lower platen, the hot plate is swung to a position above the garment and lowered thereon.

What is needed is a heat seal machine that warms quickly to allow the heat to be shut off during periods of non-use to save energy, promotes worker safety, and meets production demands.

### SUMMARY OF THE INVENTION

This invention relates to a transfer press comprising a frame, an upper platen assembly having an induction heatable upper platen, a lower platen assembly attached to the frame, whereas the lower platen assembly is disposed below the upper platen assembly, an apparatus attached to the frame and to the upper platen for moving the upper platen between a raised and lowered position relative to the lower platen and for pressing the upper platen against the lower platen, and an induction heater located adjacent the upper platen for heating the upper platen.

This invention also relates to a transfer press comprising a frame, a lower platen assembly attached to the frame and having an induction heatable lower platen, an upper platen assembly disposed above the lower platen assembly, an apparatus attached to the frame and to the upper platen for moving the upper platen between a raised and lowered position relative to the lower platen and for pressing the upper platen against the lower platen, and an induction heater located adjacent the lower platen for heating the lower platen.

This invention further relates a method for transferring a decal from a backing to a receiving article comprising providing a frame, an upper platen assembly having an induction heatable upper platen, a lower platen assembly attached to the frame, whereas the lower platen assembly is disposed below the upper platen assembly, an apparatus attached to the frame for moving the upper platen assembly between a raised and lowered position relative to the lower platen and for pressing the upper platen against the lower platen, an induction heater located adjacent the upper platen for heating the upper platen, placing a receiving article on the lower platen, placing a decal on the receiving article, heating the upper platen, and lowering the upper platen against the lower platen to transfer the decal to the receiving article.

### DETAILED DESCRIPTION OF THE DRAWINGS

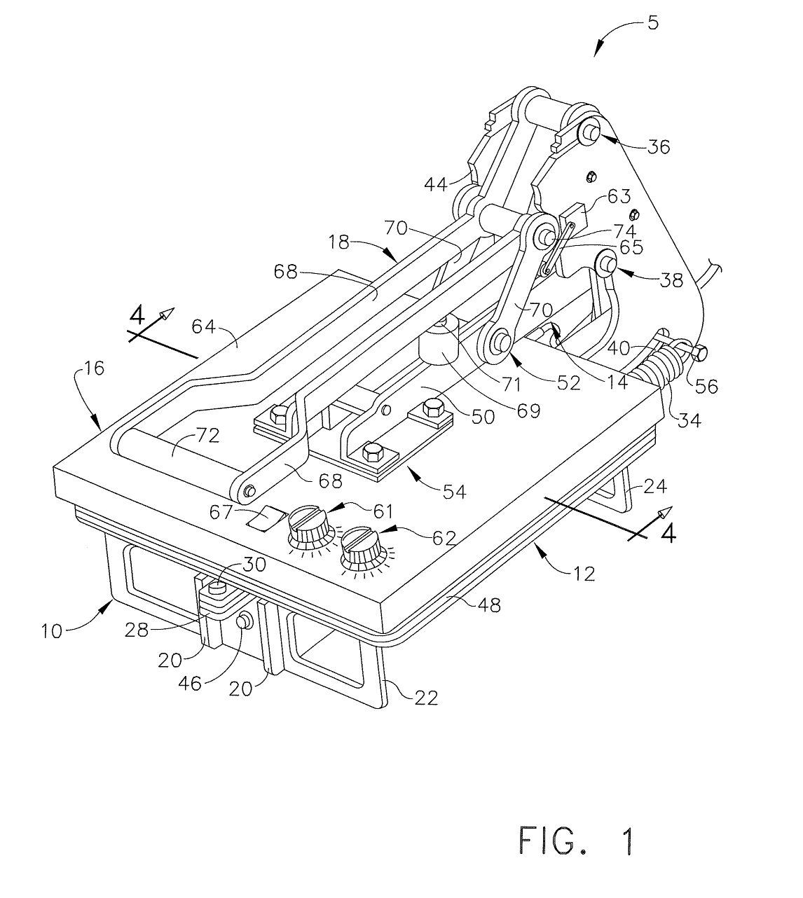

FIG. 1 is a perspective view of a heat transfer press of the invention.

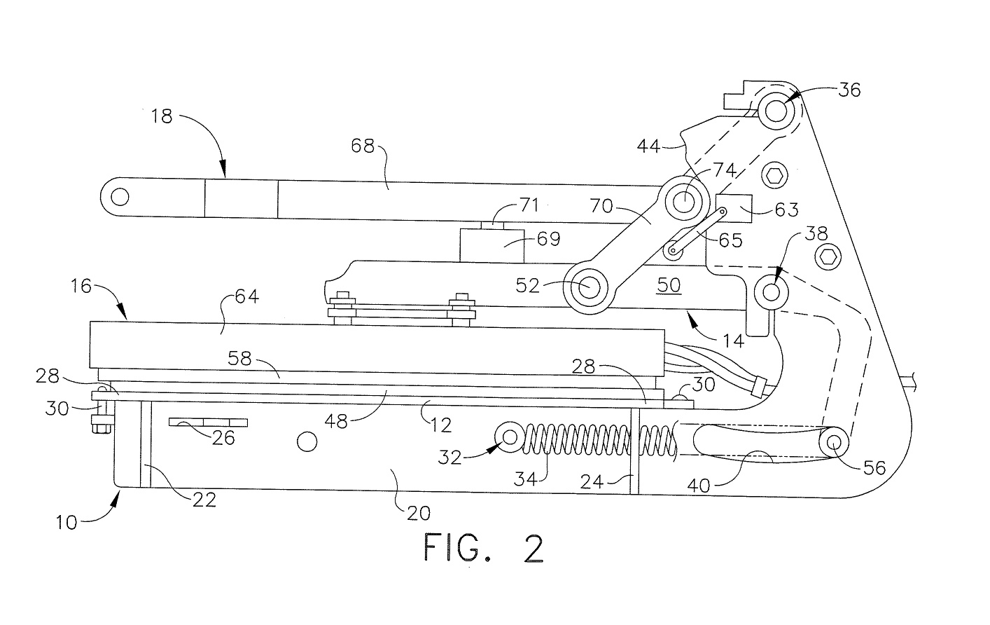

FIG. 2 is a side view of the heat transfer press of FIG. 1 with the upper platen assembly closed.

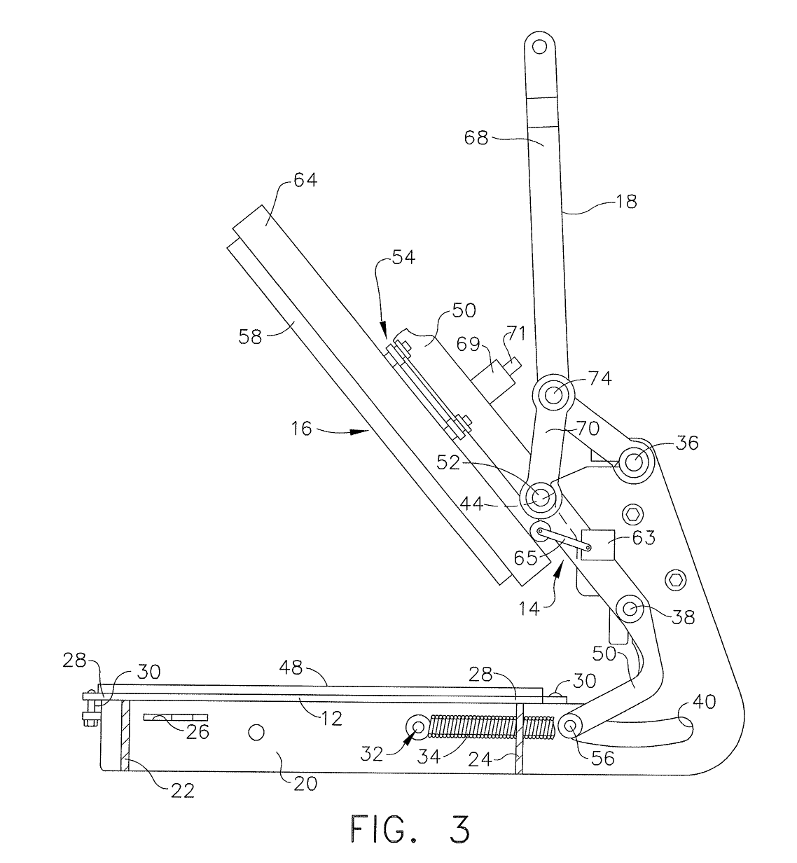

FIG. 3 is a side view of the heat transfer press of FIG. 1 with the upper platen assembly open.

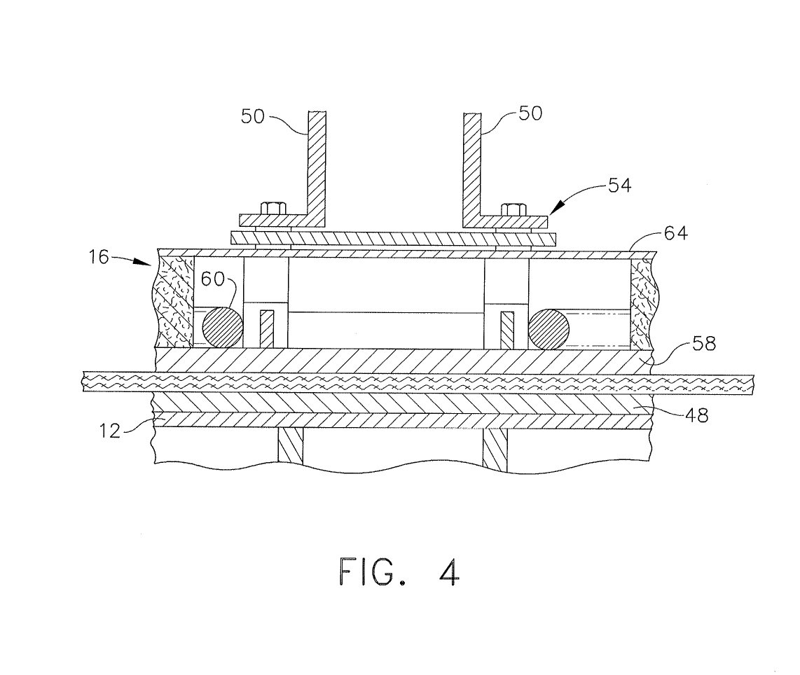

FIG. 4 is a front section partial view of the heat transfer press of FIG. 1.

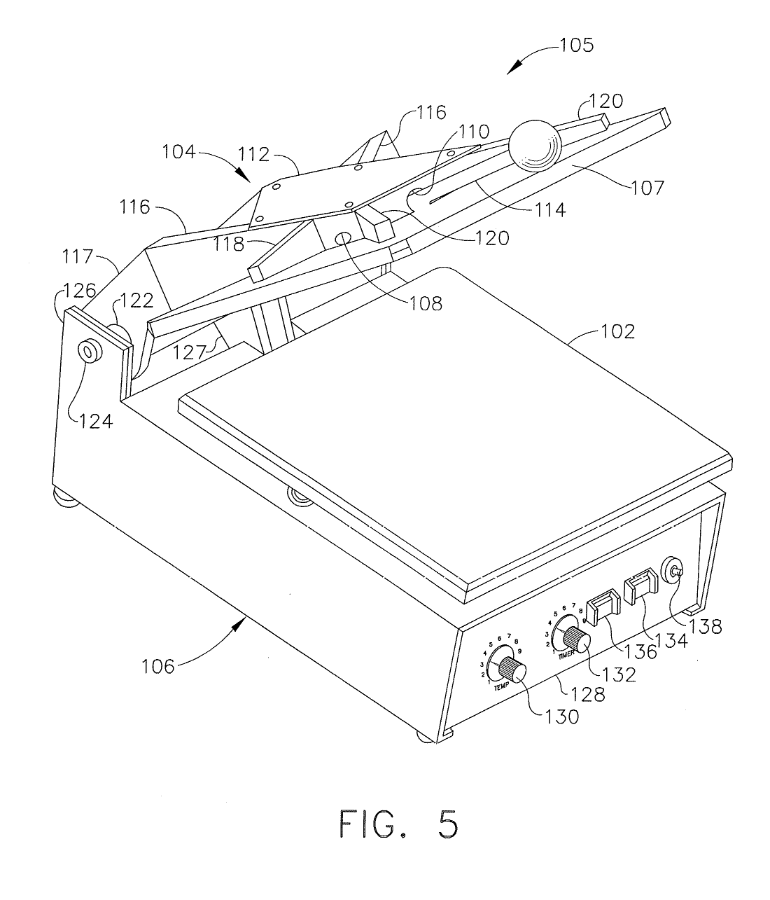

FIG. 5 is a perspective view of another heat transfer press of the invention.

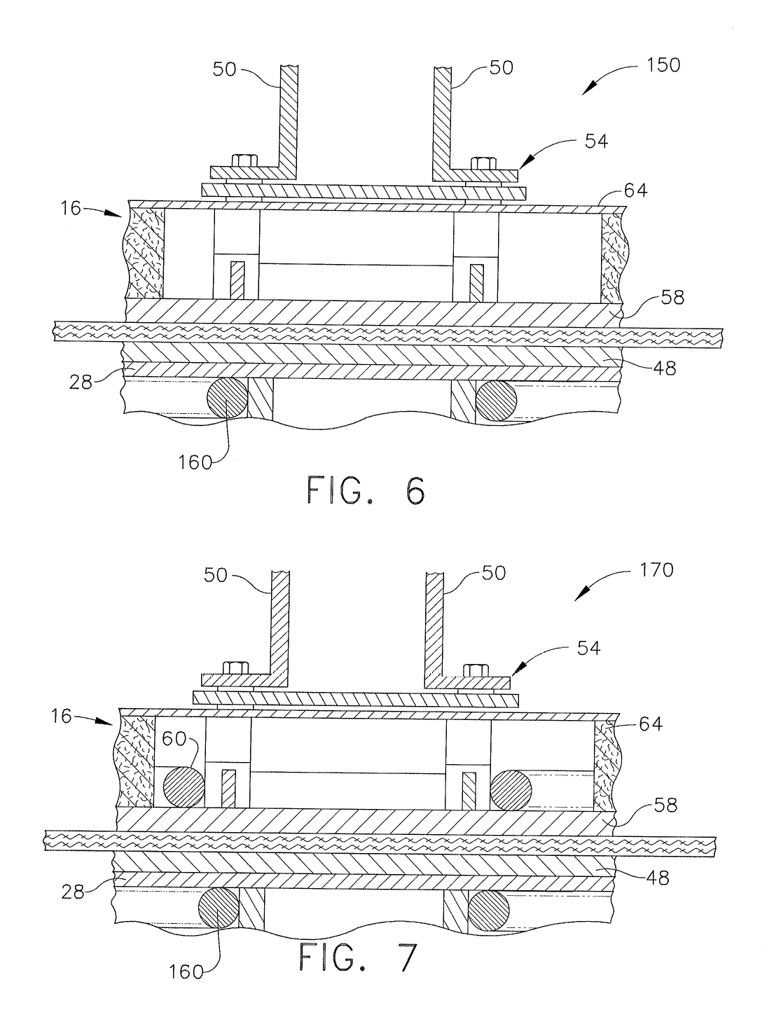

FIG. 6 is a section view of another embodiment of the invention showing the induction heaters adjacent the lower platen.

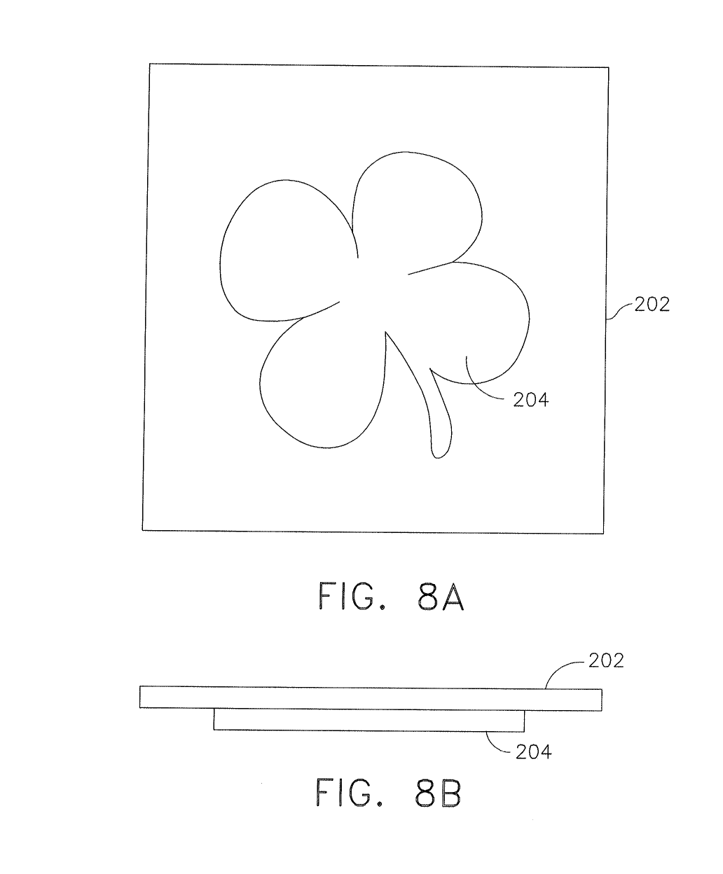

FIG. 7 is a section view of another embodiment of the invention showing induction heaters adjacent the lower platen and the upper platen.

FIG. 8A is a bottom view of a platen with a raised image.

FIG. 8B is a side view of a platen with a raised image.

### DETAILED DESCRIPTION OF THE INVENTION

Presented here is a transfer press that utilizes induction heaters to heat a platen. Induction heating is the process of heating an electrically conducting object by eddy currents in a varying electric magnetic field. While induction heating can use used to heat most metals, ferrous metals work best for induction heating due to their magnetic properties. Typically, induction heating is more efficient and provides more rapid heating and more precise temperature control when compared to traditional resistance heating. When utilized with heat transfer presses, induction heaters save energy and increase safety by allowing the user to turn the heat off when not in use, because of their ability to rapidly heat the platen.

A transfer press 5 is illustrated in FIG. 1, and includes a frame 10, a lower platen assembly 12 attached to the frame and disposed below an upper platen assembly 16, an apparatus, here a support arm assembly 14, attached to the frame for pivotal movement of the upper platen assembly between a raised and lowered position relative to the lower platen assembly. Other apparatus may be used to move the upper platen assembly between a raised and lowered position relative to the lower platen assembly. For example, an air actuator, such as an air cylinder, a hydraulic actuator, such as a hydraulic cylinder, or an electric actuator, such as a servo motor, may be used to move the upper platen assembly between a raised and lowered position relative to the lower platen assembly. When in a lowered position, the support arm assembly presses the upper platen against the lower platen. In addition, a handle assembly 18 is connected between the frame and the arm assembly for shifting the arm assembly between the raised and lowered positions and for applying pressure to the upper platen during application of a heat transfer.

The frame is defined by a pair of side walls 20 that are spaced apart from one another and secured in place by two longitudinally opposed end walls 22, 24. As shown in FIG. 2, typically the side walls 20 are identical to one another. Each is generally L-shaped, including a lower horizontal base portion and an upstanding tower portion. The base portion includes a bottom edge adapted to engage a support surface and an opposing upper edge on which the lower platen is supported.

A pair of longitudinally spaced slots are formed in the base portion and extend upward from the lower edge, defining the notches in which the front and rear end walls 22, 24 are received. The upper edge includes a pair of tabs that protrude slightly above the edge and engage the lower platen to position the platen on the frame. A transverse slot 26 is formed in each base portion immediately beneath each of the tabs for receiving a lower platen 28. The lower platen 28 typically includes a pair of laterally protruding tabs that are received in the slots 26, and a longitudinally extending tongue that protrudes through one of the end walls of the frame and presents a hole in which a conventional fastener 30 is received.

A transverse hole is formed in the base portion of each of the side walls, and a shaft 32 extends through the holes and is secured in place. The shaft 32 protrudes laterally from each hole, presenting end portions that define seats to which a preloaded mechanism, here at least one tension spring 34, is secured.

The tower portion of each side wall 20 includes an upper end defining the top of the frame and longitudinally opposed front and rear edges extending between the top edge and the base portion of the wall. An upper transverse hole is formed in each tower portion adjacent the top edge and is adapted to receive a pivot pin 36 of the handle assembly, described below. A lower transverse hole is provided in each tower portion directly beneath the upper hole, and is adapted to receive a pivot pin 38 of the support arm assembly 14. The axes of the two holes are typically disposed within a common vertical plane. An arcuate slot 40 is formed in each side wall at the base of the tower portion, and defines a center of curvature collinear with the axis of the pin 38. The front edge of the tower portion of each side wall is shaped to define an engagement or abutment surface 44, which limits travel of the support arm assembly.

Returning to FIG. 1, the end walls 22, 24 are each generally rectangular in front elevational shape, including a bottom edge adapted to engage a support surface and an opposing upper edge on which the lower platen is supported. A pair of longitudinally spaced slots are formed in each wall and extend downward from the upper edge, defining the notches in which the side walls are received. The upper edge also includes a pair of tabs that protrude slightly above the edge and engage the lower platen to position the platen on the frame. A transverse slot is formed in each end wall between the slots for receiving the tongue of the lower platen 28, as described previously. A small aperture is formed in the front end wall intermediate the slots, and is adapted to support an indicator light 46.

The lower platen 28 is generally square and presents a planar upper surface, although platens of various sizes and shapes can be used. The illustrated platen includes front and rear projections defining holes through which the fasteners 30 are received such that the platen 28 can be secured to the frame. Longitudinally extending slots are formed in the platen which are positioned to engage the tabs of the side walls, and laterally extending slots are formed adjacent the front and rear edges of the platen for engagement with the tabs presented by the end walls. As shown in FIG. 3, a pad 48 of silicon or other compressible material is adhered or otherwise supported on the upper surface of the lower platen for distributing pressure evenly across a substrate during application of a heat transfer.

The support arm assembly 14 is shown in FIG. 2, and includes a pair of laterally spaced, longitudinally extending support arms 50, wherein each arm includes horizontally extending front section and a vertical rear section. A transverse hole is formed in each arm adjacent the rear of the front section for receiving the pivot pin 38 supports the arms in the lower aperture of the frame for pivotal movement between an upper position in which the front sections of the arms are raised away from the lower platen assembly, as shown in FIG. 3, and a lowered position, shown in FIG. 2, in which the front sections of the arms are lowered into a position adjacent the lower platen assembly. A rear hole is provided in the arms and is sized to receive a pivot pin 52 which connects the arms to the handle assembly 18.

As shown in FIG. 3, the rear section of each mounting arm includes a lower end with a hole for receiving a pin 56. The pin protrudes beyond the holes in the arms into the slots 40 of the side walls 20, and defines a seat by which the two springs are supported. The springs 34 exert a tension on the lower ends of the arms 50 with sufficient force to lift the arms to the raised position and support them there.

As illustrated in FIGS. 1 and 2, the upper platen assembly 16 includes an upper platen 58, at least one induction heating element 60, shown in FIG. 4, for heating the upper platen, a thermostat 62 for controlling the operation and regulating the temperature of the heating element, a master switch 67 for turning power on and off, a timer 61 for controlling the cycle time, and a cover or heat shield 64 enclosing the heating element and thermostat. Typically, because of the induction heating element, the upper platen is made from an induction heatable material, such as a ferrous material or other material capable of being heated by an induction heater, and other components are made of materials that are not significantly heated by induction, such as nonferrous materials including aluminum and plastic.

The platen may also be made to print, imprint or burn indicia, or emboss items such as footballs. Shown in FIGS. 8A and 8B is a platen that may be used for those purposes. The platen 202 is similar to a standard platen, except it may be made from non-induction heatable material, such as a non-ferrous material, for reasons described later. Attached to the platen is an image plate 204 of the image that the user wants to print, burn, or emboss into an item, which in FIG. 8A is a four leaf clover. For printing, ink can be applied to the image plate 204 and the upper platen assembly to which the platen is typically attached, is lowered until the image plate 204 meets the item to be printed and transfers the ink by contact to the item.

A platen to burn indicia using an induction heater could use an induction heatable material, such as a ferrous material, for the image plate 204 and a non-induction heatable material, such as a nonferrous material, for the platen 202. In that case, the induction heater would heat primarily the image plate 204 and not the platen 202. The heated image plate could then be used to burn an indicia onto an item, such as a leather football. The platen 202 and the image plate 204 could be made in a variety of shapes and curvatures to mate with the item, such as a football, baseball, basketball or hat, to be printed, burned, or embossed. Various types and shapes of image plates 204 may be used. For example, one type could include an outline of the shape so that only the outline is printed, burned, or embossed on the item.

The thermostat 62, as shown in FIG. 1, may include a feature for turning the heating element on and off in addition to controlling the temperature of the heating element. The knob protrudes above the heat shield 64, and marks are provided on the surface of the shield around the knob for indicating the positions of the knob. An indicator light 46 forms a part of the thermostat, and is mounted in the hole in the front end wall of the frame within easy view of a user. The light 46 is activated when the thermostat is turned to any “on” position, and remains lit until the heating element has reached the preset temperature. Thereafter, the light goes out, indicating that the decal transfer press is ready for use. Alternatively, a digital control may be used. The digital control may incorporate the indicator light, on/off control, temperature control, and other controls necessary or desired to control the decal transfer press.

The upper platen 58 generally corresponds in size and shape to the lower platen 28, and typically includes a planar bottom surface facing the lower platen so that when the platens are brought together during application of a transfer, the transfer is heated and pressed against the substrate. Platen shapes other than planar platens may also be used. For example, a heat transfer press for transferring decals to hats such as baseball hats typically utilizes curved upper and lower platens to conform to the curvature of the baseball hat. The other elements of the heat transfer press, including the induction heaters, are also application to a heat transfer press using curved platens.

Referring to FIG. 4, the upper surface of the upper platen 58 is sized to receive the induction heating element 60 adjacent the upper platen 58. The induction heating element can be of any desired shape that provides substantially uniform heating of the platen without creating hot spots. Multiple heating elements may be used to heat uniformly the platen.

The cover or shield 64 includes a top wall and a perimeter side wall. The top wall include holes for the knob of the thermostat 62 and for various components of the pressure adjustment assembly. When closed, the cover protects users from direct exposure to the heating element and wiring to the thermostat.

The handle assembly 18 includes a pair of laterally spaced, longitudinally extending levers 68 and a pair of links 70. Each lever 68 includes a generally horizontally extending front section and an upwardly angled rear section. A transverse hole is located at the front of each lever, and a handle or grip 72 is secured in place between the levers by fasteners extending through the holes. A second transverse hole is formed in each lever at the rear end of the rear section for receiving the pivot pin 36 to support the levers in the upper aperture of the frame for pivotal movement between raised and lowered positions. A third transverse hole is formed in each lever at the point of intersection of the front and rear sections, and is sized to receive a pivot pin 74 by which the links 70 are supported on the lever for pivotal movement. The links 70 are supported between the pin 74 on the levers and the pin 52 on the support arms and transfer movement of the levers to the support arms, shifting the support arms between the upper and lower positions.

Referring to FIGS. 3 and 4, the pivot pin 36 of the levers and the pivot pin 52 between the links 70 and the support arms 50 define longitudinal axes that are disposed in a common plane. The pivot axis, defined by the pin 74 supporting the links on the levers, defines another longitudinal axis, wherein the axis of the pin 74 is displaced slightly below the plane in the lowered position of the support arms, shown in FIG. 5, and is displaced above the plane in the raised position of the support arms, shown in FIG. 4. As such, the linkage of the handle assembly 18 defines an over-center or over-toggle arrangement that allows the springs 34 to bias the upper platen 58 toward the raised and lowered positions depending on whether the axis of the pin 74 is disposed above or below the plane defined by the pins 36, 52. The limit positions of the support arms 50 are defined by the stop surface 44 of the frame tower which are engaged by the links 70 to prevent further movement in either direction.

A release mechanism 69 is mounted on the support arm 50 and operates against the lever 68. Typically, the release mechanism is a cylinder, such as an air cylinder, having a body and rod 71 or a solenoid having a body and rod 71. Other types of mechanisms adapted to release the upper platen assembly may also be used. When the upper platen assembly 16 is closed against the lower platen assembly 12, the lever 68 operates against the rod 71 and pushes the rod into the body of the release mechanism. When power, in the form of electric or air, or other source depending on the type of release mechanism used, is applied to the release mechanism, the rod extends out of the body and pushes against the lever 68. The force against the lever 68 unlocks the over-center locking of the handle assembly 18, allowing the springs 34, (one type of a preloaded mechanism), which are tensioned to open the upper platen assembly when it is closed, to open the upper platen assembly.

The timer 61 controls a release mechanism 69. In operation, the user sets the timer to the desired press time and lowers the upper platen assembly against the lower platen assembly with the handle 72. The lowered handle causes the link 70 to actuate a switch 63 that is attached to the frame 10. The switch shown in FIG. 1 is a limit switch with a lever 65. When the lever 65 is engaged, it operates the switch 63 which starts the time 61. The timer, which is preset by the operator, counts to a predetermined amount of time, and then times out. When the timer times out, it operates a release mechanism 69. In the embodiment of FIG. 1, the release mechanism is mounted on the support arm 50 and operates against lever 68.

The switch may also be used to turn on power to the induction heaters. When used to turn on power, the induction heaters are off when the upper platen assembly is in the raised position. When the upper platen assembly is lowered against the lower platen, the switch closes, thereby turning on the induction heaters. The switch may also start the timer in addition to turning on the induction heaters.

In operation, the thermostat 62 is set to the desired temperature of the platen 58, and the receiving article, such as a t-shirt, is placed the lower platen 28 and the decal or transfer is placed on the receiving article. Once the desired temperature is reached, the indicator light 46 goes out, and the operator grips the handle 72 and lowers the upper platen against the lower platen. Alternatively, if the switch 63 is used to turn on the induction heaters, then the upper platen is lowered before the desired temperature is reached. The linkage of the handle assembly 18 forces the support arms 50 to the lowered position, exerting pressure against the upper platen assembly. If the upper platen 58 is adjusted to a position relatively high on the support arms, a relatively low pressure is exerted on the transfer. If the position of the upper platen on the arms is relatively low, a greater pressure is exerted. The compressed forced stored in the pad 48 retains the support arms in the lowered position during application of the transfer due to the over-center design of the handle assembly. The handle 72 is manually lifted after a predetermined time has lapsed to allow removal of the transfer and substrate. Alternatively, if a release mechanism 69 is included on the transfer press, then the release mechanism unlocks the over the center lock and allows the springs to raise the upper platen assembly.

The amount of time the upper platen is pressed against the lower platen (dwell time), the heat, and the pressure vary depending upon the decal or transfer and the substrate or receiving article. For example, for clothing decoratives, the temperature is typically between 280° and 390° F., the platen pressure is typically between 2 and 10 psi, more typically between 2 and 6 psi, and the dwell time is typically between 2 and 30 seconds. For indicia, the temperature is typically between 300° and 350° F., the plate pressure is typically between 4 and 10 psi, and the dwell time is typically between 5 and 20 seconds. For sublimation print transfers, the temperature is typically between 375° and 400° F., the plate pressure is typically between 2 and 8 psi, and the dwell time is typically between 20 and 60 seconds. For foil stamping substrates such as mudflaps, the temperature is typically between 325° and 385° F., the pressure is typically between 800 and 1200 psi, and the dwell time is typically between 2 and 3 seconds. For flat stamping substrates such as mudflaps, the temperature is typically between 320° and 340° F., the pressure is typically between 50 and 100 psi, and the dwell time is typically between 8 and 20 seconds.

In another embodiment of a heat transfer press 105 is shown in FIG. 5, a lower platen 102 and an upper platen assembly 104 are mounted on a base 106. The upper platen assembly 104 has an upper platen 107, and attached adjacent the upper platen assembly 104 is an induction heater 108. Extending from a front opening 110 in a central body portion 112 of upper platen assembly 104 is a self-centering control lever 114 which is pivotally mounted within body portion 112 for up and down movement of the press.

Three upstanding reinforcing ribs 116, 118 and 120 fan out from each side of central body portion 112 to give structural rigidity to upper platen assembly 104. The rearmost ribs 116 on each side of the press have terminal portions 117 which run parallel to the left and right sides of base 106 and are fixed to a cylindrical shaft 122 rotatably supported at the rear of base 106 on journals 124 provided in upstanding ears 126 at the respective rear corners of base 106. Rotation of shaft 122 on journals 124 to raise and lower the upper platen assembly 104 is imparted through a pair 127 of parallel crank arms rigidly secured at one end thereof to the underside of shaft 122.

Base 106 is provided with a front panel 128 having a temperature adjustment knob 130 to control the temperature of the induction heater 108 and upper platen assembly 104. A time adjustment knob 132 on front panel 128 determines the length of the time period the press will be in its closed condition during its cycle of operation. A first switch button 134 on front panel 128 controls electrical power to the press, and a second switch button 136 operates an Auto-Start switch for starting an operating cycle of the press. A reset button 138 for a conventional circuit breaker (not shown) protects the press from electrical overloads.

In an embodiment of a heat transfer press 150 depicted in FIG. 6, the lower platen is heated by at least one induction heater 160 located adjacent the lower platen. When the lower platen is heated, a pad 48 may or may not be included on the lower plate. In this embodiment, the other parts of the decal transfer press are made from non-ferrous or other materials that will not be heated significantly by the induction heater. Other features of this embodiment, such as the heat sensor, thermostat, release mechanism, and timer, are typically similar to those described previously, although they may operate on the lower platen instead of the upper platen as appropriate.

In an embodiment of a heat transfer press 170 depicted in FIG. 7, the upper platen assembly includes an induction heatable upper platen and an induction heater located adjacent the upper platen and an induction heatable lower platen and an induction heater located adjacent the lower platen. When the lower platen is heated, a pad 48 may or may not be included on the lower plate. When used with dual heated platens, the heat transfer press may come up to operating temperature faster. Other features of this embodiment, such as the heat sensor, thermostat, release mechanism, and timer, are typically similar to those described previously.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

1. A transfer press, comprising
a. a frame,
b. an upper platen assembly having an induction heatable upper platen,
c. a lower platen assembly attached to the frame, whereas the lower platen assembly is disposed below the upper platen assembly,
d. an apparatus attached to the frame and to the upper platen for moving the upper platen between a raised and lowered position relative to the lower platen and for pressing the upper platen against the lower platen, and
e. an induction heater located adjacent the upper platen for heating the upper platen.

2. The transfer press according to claim 1, further comprising a heat sensor communicating with the upper platen and a thermostat connected to the heat sensor for regulating the temperature of the upper platen.

3. The transfer press according to claim 1, further comprising a preloaded mechanism secured to the frame for moving the upper platen assembly away from the lower platen assembly.

4. The transfer press according to claim 1, wherein the apparatus for moving the upper platen relative to the lower platen comprises a support arm assembly.

5. The transfer press according to claim 4, further comprising a release mechanism mounted to the support arm for unlocking the upper platen assembly from the lower platen assembly and allowing the preloaded mechanism to move the upper platen assembly away from the lower platen assembly.

6. The transfer press according to claim 5, further comprising a timer for operating the release mechanism.

7. The transfer press according to claim 1, wherein the lower platen assembly has a induction heatable lower platen and further comprising an induction heater located adjacent the lower platen for heating the lower platen.

8. The transfer press according to claim 1, further comprising a switch attached to the frame for turning on power to the induction heater when the upper platen assembly is lowered.

9. A transfer press, comprising
a. a frame,
b. a lower platen assembly attached to the frame and having an induction heatable lower platen,
c. an upper platen assembly disposed above the lower platen assembly,
d. an apparatus attached to the frame and to the upper platen for moving the upper platen between a raised and lowered position relative to the lower platen and for pressing the upper platen against the lower platen, and
e. an induction heater located adjacent the lower platen for heating the lower platen.

10. The transfer press according to claim 9, further comprising a heat sensor communicating with the lower platen and a thermostat connected to the heat sensor for regulating the temperature of the lower platen.

11. The transfer press according to claim 9, further comprising a preloaded mechanism secured to the frame for moving the upper platen assembly away from the lower platen assembly.

12. The transfer press according to claim 9, wherein the apparatus for moving the upper platen assembly relative to the lower platen comprises a support arm assembly.

13. The transfer press according to claim 12, further comprising a release mechanism mounted to the support arm for unlocking the upper platen assembly from the lower platen assembly and allowing the preloaded mechanism to move the upper platen assembly away from the lower platen assembly.

14. The transfer press according to claim 13, further comprising a timer for operating the release mechanism.

15. The transfer press according to claim 9, further comprising a switch attached to the frame for turning on power to the induction heater when the upper platen assembly is lowered.

16. A method for transferring a decal from a backing to a receiving article, comprising
a. providing a frame, an upper platen assembly having an induction heatable upper platen, a lower platen assembly attached to the frame, whereas the lower platen assembly is disposed below the upper platen assembly, an apparatus attached to the frame for moving the upper platen assembly between a raised and lowered position relative to the lower platen and for pressing the upper platen against the lower platen, an induction heater located adjacent the upper platen for heating the upper platen,
b. placing a receiving article on the lower platen,
c. placing a decal on the receiving article,
d. heating the upper platen, and
e. lowering the upper platen against the lower platen to transfer the decal to the receiving article.

17. The method according to claim 16, further comprising releasing the upper platen with a release mechanism and automatically raising the upper platen.

18. The method according to claim 17, further comprising a timer for operating the release mechanism and releasing the upper platen after a predetermined amount of time.

19. The method according to claim 16, further comprising regulating the temperature of the upper platen.
